(19) United States
(12) Patent Application Publication
(10) Pub. No.: US 2026/0197064 A1
(43) Pub. Date: Jul. 9, 2026

(54) METHOD, DEVICE AND COMPUTER STORAGE MEDIUM OF COMMUNICATION

(71) Applicant: NEC Corporation, Tokyo (JP)

(72) Inventors: Minghui XU, Beijing (CN); You LI, Beijing (CN); Gang WANG, Beijing (CN)

(73) Assignee: NEC Corporation, Tokyo (JP)

(21) Appl. No.: 19/129,395

(22) PCT Filed: Nov. 17, 2022
(86) PCT No.: PCT/CN2022/132694

§ 371 Date: May 13, 2025

(51) Int. Cl. H04B 7/06

(52) U.S. Cl. CPC H04B 7/0695

(57) ABSTRACT

Embodiments of the present disclosure relate to methods, devices and computer readable media for communication. In one aspect, a network device receives, from at least one repeater device in a set of repeater devices, beam information of the at least one repeater device. Based on the beam information, the network device determines information of a scheme for signal forwarding via the at least one repeater device. The network device transmits the information of the scheme to the at least one repeater device. In this way, a signal forwarding scheme of a NCR may be flexibly determined.

### TECHNICAL FIELD

Embodiments of the present disclosure generally relate to the field of telecommunication, and in particular, to methods, devices and computer storage media of communication for signal forwarding of a network-controlled repeater (NCR).

### BACKGROUND

Recently, a NCR is introduced by adding side control information for beam management on a basis of a radio frequency (RF) repeater to extend coverage in a high frequency (HF) with a higher efficient method. It has been approved to specify a signaling and behaviour of side control information for controlling a NCR. However, a procedure for signal forwarding of a NCR is still undefined and needs to be developed.

### SUMMARY

In general, embodiments of the present disclosure provide methods, devices and computer storage media of communication for signal forwarding of a NCR.

In a first aspect, there is provided a method of communication. The method comprises: receiving, at a network device and from at least one repeater device in a set of repeater devices, beam information of the at least one repeater device; determining, based on the beam information, information of a scheme for signal forwarding via the at least one repeater device; and transmitting the information of the scheme to the at least one repeater device.

In a second aspect, there is provided a method of communication. The method comprises: transmitting, at a repeater device and to a network device, beam information of the repeater device; receiving, from the network device, information of a scheme for signal forwarding via the repeater device; and performing signal forwarding based on the scheme.

In a third aspect, there is provided a method of communication. The method comprises: determining, at a network device, a first mapping between a set of first beams of the network device for reference signal transmission and a set of second beams of a repeater device for reference signal forwarding; and transmitting the first mapping to the repeater device.

In a fourth aspect, there is provided a method of communication. The method comprises: determining, at a repeater device, a first mapping between a set of first beams of a network device for reference signal transmission and a set of second beams of the repeater device for reference signal forwarding; and performing the reference signal forwarding based on the first mapping.

In a fifth aspect, there is provided a method of communication. The method comprises: receiving, at a repeater device and from a network device, a mapping between a set of first beams of the network device for reference signal transmission and a set of second beams of the repeater device for reference signal forwarding; determining an application time of the mapping; and applying, based on the application time, the mapping for the reference signal forwarding.

In a sixth aspect, there is provided a method of communication. The method comprises: transmitting, at a network device and to a repeater device, a mapping between a set of first beams of the network device for reference signal transmission and a set of second beams of the repeater device for reference signal forwarding; determining an application time of the mapping; and applying, based on the application time, the mapping for reception of a feedback for the reference signal transmission.

In a seventh aspect, there is provided a device of communication. The device comprises a processor configured to cause the device to perform the method according to any of the first to sixth aspects of the present disclosure.

In an eighth aspect, there is provided a computer readable medium having instructions stored thereon. The instructions, when executed on at least one processor, cause the at least one processor to perform the method according to any of the first to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication scenario in which some embodiments of the present disclosure can be implemented;

FIG. 1B illustrates an example communication model of a NCR in which some embodiments of the present disclosure can be implemented;

FIG. 2 illustrates a schematic diagram illustrating an example process of communication according to some embodiments of the present disclosure;

FIG. 3 illustrates a schematic diagram illustrating another example process of communication according to some embodiments of the present disclosure;

FIG. 4 illustrates a schematic diagram illustrating still another example process of communication according to some embodiments of the present disclosure;

FIG. 5A illustrates a schematic diagram illustrating an example determination of an application time of a mapping between transmitting (Tx) beams of a network device and Tx beams of a NCR according to some embodiments of the present disclosure;

FIG. 5B illustrates a schematic diagram illustrating another example determination of an application time of a mapping between Tx beams of a network device and Tx beams of a NCR according to some embodiments of the present disclosure;

FIG. 6A illustrates a schematic diagram illustrating another example determination of an application time of a mapping between Tx beams of a network device and Tx beams of a NCR according to some embodiments of the present disclosure;

FIG. 6B illustrates a schematic diagram illustrating another example determination of an application time of a mapping between Tx beams of a network device and Tx beams of a NCR according to some embodiments of the present disclosure;

FIG. 7A illustrates a schematic diagram illustrating another example determination of an application time of a mapping between Tx beams of a network device and Tx beams of a NCR according to some embodiments of the present disclosure;

FIG. 7B illustrates a schematic diagram illustrating another example determination of an application time of a mapping between Tx beams of a network device and Tx beams of a NCR according to some embodiments of the present disclosure;

FIG. 8 illustrates an example method of communication implemented at a network device in accordance with some embodiments of the present disclosure;

FIG. 9 illustrates an example method of communication implemented at a repeater device in accordance with some embodiments of the present disclosure;

FIG. 10 illustrates another example method of communication implemented at a network device in accordance with some embodiments of the present disclosure;

FIG. 11 illustrates another example method of communication implemented at a repeater device in accordance with some embodiments of the present disclosure;

FIG. 12 illustrates an example method of communication implemented at a repeater device in accordance with some embodiments of the present disclosure;

FIG. 13 illustrates an example method of communication implemented at a network device in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “repeater” may be interchangeably used with “repeater device” or “network-control repeater” or “intelligent reflecting surface” or “Reconfigurable Intelligence Surface”, and the term “beam” may be interchangeably used with “link” or “channel” or “spatial filter”. In the context of the present application, the term “side control information” may be interchangeably used with “control information” or “on-off information”. In the context of the present application, the term “synchronization signal and physical broadcast channel block (SSB) index” may be interchangeably used with “channel state information-reference signal (CSI-RS) index”.

In the context of the present application, a slot may comprise 14 symbols if a cyclic prefix (CP) length is a normal CP, and a slot may comprise 12 symbols if a CP length is an extended cyclic prefix (ECP). For convenience, embodiments of the present disclosure are described in connection with a normal CP. It is to be understood that embodiments of the present disclosure may also be applied in connection with ECP.

Currently, it is intended to study and identify which side control information below is necessary for network-controlled repeaters including assumption of maximum transmission power:
beamforming information;
timing information to align transmission/reception boundaries of a network-controlled repeater;
information on uplink (UL)-downlink (DL) time division duplexing (TDD) configuration;
on-off information for efficient interference management and improved energy efficiency;
power control information for efficient interference management (as the second priority).

As mentioned above, a procedure for signal forwarding of a NCR is still undefined and needs to be developed. In view of this, embodiments of the present disclosure provide a solution for signal forwarding of a NCR. In one aspect, a network device receives beam information of at least one NCR, determines information of a scheme for signal forwarding via the at least one NCR, and transmits information of the scheme to the at least one NCR. The at least one NCR determines the scheme based on the information of the scheme and performs signal forwarding based on the scheme. In this way, a signal forwarding scheme may be flexibly chosen according to beam information of a NCR.

In another aspect, a network device determines a mapping (for convenience, also referred to as a first mapping herein) between a set of first beams of the network device for reference signal transmission and a set of second beams of a NCR for reference signal forwarding, and transmits the mapping to the NCR. The NCR performs the reference signal forwarding based on the mapping. In this way, compatibility with a legacy reference signal transmission procedure may be achieved and fairness of measurements for Tx beams of a NCR may be ensured.

In still another aspect, a network device transmits, to a NCR, a mapping between a set of first beams of the network device for reference signal transmission and a set of second beams of the NCR for reference signal forwarding. The network device determines an application time of the mapping, and applies, based on the application time, the mapping for reception of a feedback for the reference signal transmission. The NCR determines the application time of the mapping, and applies, based on the application time, the mapping for the reference signal forwarding. In this way, reference signal transmission and forwarding may be efficiently performed.

Principles and implementations of the present disclosure will be described in detail below with reference to the figures.

### Example of Communication Network

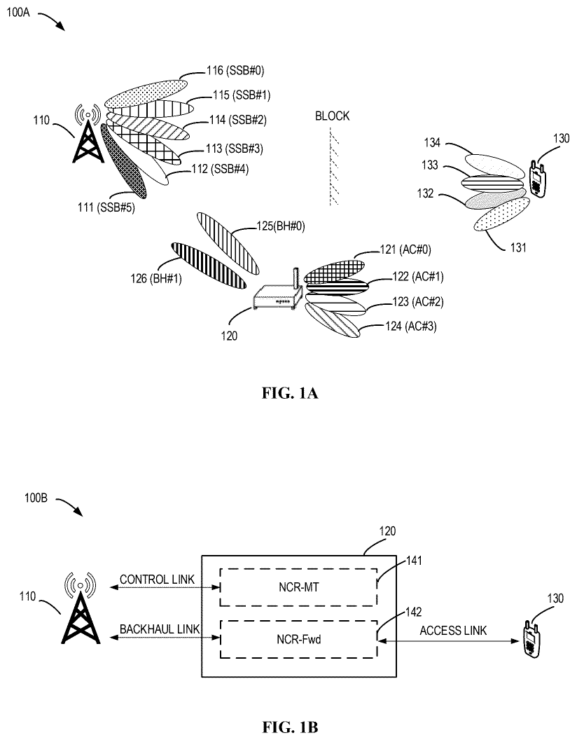

FIG. 1A illustrates a schematic diagram of an example communication network 100A in which embodiments of the present disclosure can be implemented. As shown in FIG. 1A, the communication network 100A may comprise a network device 110, a repeater device 120 and a terminal device 130. The network device 110 may serve the terminal device 130.

In some embodiments, the network device 110 may directly communicate with the terminal device 130. In this case, a link between the network device 110 and the terminal device 130 is a direct link. In some embodiments, the network device 110 may communicate with the terminal device 130 via the repeater device 120. In this case, a link between the network device 110 and the terminal device 130 via the repeater device 120 is an indirect link.

The repeater device 120 may have a forwarding function (also referred to as a normal operation mode) and a monitoring function (also referred to as a low power consumption mode). In the normal operation mode, the repeater device 120 may forward a signal transmission between the network device 110 and the terminal device 130. That is, the repeater device 120 may receive a signal from the network device 110, then amplify the received signal and forward the amplified signal to the terminal device 130. Or the repeater device 120 may receive a signal from the terminal device 130, then amplify the received signal and forward the amplified signal to the network device 110. In the low power consumption mode, the repeater device 120 may intermittently or periodically monitor a signal from the network device 110.

In some embodiments, the network device 110 may transmit side control information to the repeater device 120. The side control information may comprise at least one of the following: beamforming information, timing information to align transmission or reception boundaries of the repeater device 120, information on UL-DL TDD configuration, on-off information for efficient interference management and improved energy efficiency, or power control information for efficient interference management.

As shown in FIG. 1A, the network device 110 may support six beams 111, 112, 113, 114, 115 and 116 for communication, the repeater device 120 may support five beams 121, 122, 123, 124, 125 and 126 for communication, and the terminal device 130 may support four beams 131, 132, 133 and 134 for communication. These beams may serve as Tx beams or receiving (Rx) beams in DL or UL transmission. For convenience, assuming that the beams 111, 112, 113, 114, 115 and 116 are Tx beams of the network device 110 in DL transmission, the beams 121, 122, 123 and 124 are Tx beams of the repeater device 120 in DL transmission, the beams 125 and 126 are Rx beams of the repeater device 120 in DL transmission, and the beams 131, 132, 133 and 134 are Rx beams of the terminal device 130 in DL transmission. In some scenarios, there may be only one beam (e.g., the beam 125) as an Rx beam of the repeater device 120 in DL transmission.

It is to be understood that the number of devices or beams in FIG. 1A is given for the purpose of illustration without suggesting any limitations to the present disclosure. The communication network 100A may involve any suitable number of network devices and/or repeater devices and/or terminal devices and/or beams adapted for implementing implementations of the present disclosure.

The communications in the communication network 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 1B illustrates an example communication model 100B of a NCR in which some embodiments of the present disclosure can be implemented. For convenience, this will be described with reference to the example of FIG. 1A. As shown in FIG. 1B, the NCR 120 may comprise a mobile termination element (denoted as NCR-MT) 141 and a forwarding element (denoted as NCR-Fwd) 142. The NCR-MT 141 may be defined as a function entity to communicate with the network device 110 via a control link to enable information exchange (e.g., side control information). The control link may be based on a Uu interface. The side control information may be at least used for the control of the NCR-Fwd 142. The NCR-Fwd 142 may defined as a function entity to perform the amplify-and-forwarding of UL/DL RF signal between the network device 110 and the terminal device 130 via a backhaul link and an access link. The behavior of the NCR-Fwd 142 will be controlled according to the received side control information from the network device 110.

It has been agreed that the following information can be used to characterize one or more physical beams supported by a NCR-Fwd for an access link: a number of beams supported for an access link; spatial relationship between different beams. It has also been agreed that both a dynamic beam indication and a semi-static beam indication are recommended for an access link, and a NCR-MT can support adaptive beams in a control link.

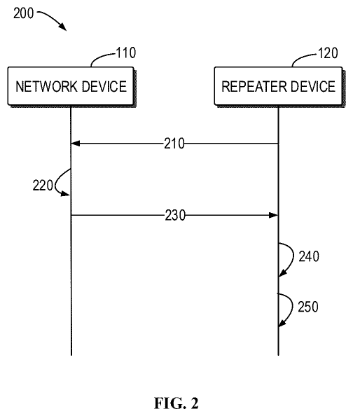

Embodiments of the present disclosure provide solutions for signal forwarding of a NCR. The solutions will be described below with reference to FIGS. 2 to 7B.

### Example Implementation of Determination of Signal Forwarding Scheme

In some scenarios, a NCR may only forward a reference signal which can be received by the NCR. Different Rx beams (e.g., the beams 125 and 126) are used to receive reference signals from different directions. In this case, a legacy mechanism of reference signal transmission may be reused for a network device irrespective of whether a NCR is introduced. In these scenarios, a reference signal index may not need to be extended. This signal forwarding scheme of a NCR may be called as a scheme (for convenience, also referred to as a first scheme herein) without extending a reference signal (RS) index. The term “a scheme without extending a RS index” may also be interchangeably used with the term “a scheme without allocating a dedicated RS index or resource for a terminal device to measure an access beam of a NCR”.

In some scenarios, only one Rx beam (e.g., the beam 125) of a NCR is used to receive reference signals from a network device. Additional reference signal indexes and resources are allocated for each beam of a NCR. In this case, overhead of a reference signal transmission may increase with increasing number of NCRs or beams of a NCR. In these scenarios, a reference signal index may need to be extended. This signal forwarding scheme of a NCR may be called as a scheme (for convenience, also referred to as a second scheme herein) with extending a RS index. The term “a scheme with extending a RS index” may also be interchangeably used with the term “a scheme with allocating a dedicated RS index or resource for a terminal device to measure an access beam of a NCR”.

However, it is still unclear how to use these signal forwarding schemes. Embodiments of the present disclosure provide a solution of determining a signal forwarding scheme. The solution will be described in connection with FIG. 2 below.

FIG. 2 illustrates a schematic diagram illustrating an example process 200 of communication according to some embodiments of the present disclosure. For the purpose of discussion, the process 200 will be described with reference to FIG. 1. The process 200 may involve the network device 110 and the repeater device 120 as illustrated in FIG. 1A. It is to be noted that the process 200 may comprise more additional steps or omit some steps shown, and the present disclosure does not limit the order of the steps.

As shown in FIG. 2, the repeater device 120 may transmit 210 beam information of the repeater device 120 to the network device 110. In some embodiments, the beam information may comprise a number of beams of the repeater device 120. It is to be understood that any other suitable beam information may also be feasible.

The network device 110 may be associated with a set of repeater devices. Accordingly, the network device 110 may receive beam information of at least one repeater device in the set of repeater devices.

The network device 110 may determine 220 information of a scheme for signal forwarding via the at least one repeater device. In some embodiments, the at least one repeater device may comprise all repeater devices in the set of repeater devices. In some embodiments, the at least one repeater device may comprise one repeater device in the set of repeater devices. In some embodiments, the network device 110 may determine the scheme. In some embodiments, the network device 110 may determine a threshold (for convenience, also referred to as a fourth threshold number herein) for determination of the scheme by the at least one repeater device. For illustration, some example embodiments will be described in connection with Embodiments 1 to 3.

### Embodiment 1

In this embodiment, the network device 110 may receive beam information of each repeater device in the set of repeater devices, and determine the scheme for signal forwarding via the set of repeater devices.

In some embodiments, the network device 110 may determine, from the beam information, a number (for convenience, also referred to as a first number herein) of beams associated with the set of repeater devices. That is, the network device 110 may determine a total number of beams of all repeater devices associated with the network device 110.

In some embodiments, one threshold number (denoted as Nth) may be defined for comparison with the first number of beams to determine which scheme is chosen. In some embodiments, if the first number of beams is above Nₜₕ (e.g., greater than or equal to Nₜₕ), the network device 110 may determine, as the scheme for signal forwarding via the set of repeater devices, the first scheme without extending a reference signal index. In some embodiments, if the first number of beams is below Nₜₕ (e.g., smaller than or equal to Nₜₕ), the network device 110 may determine, as the scheme for signal forwarding via the set of repeater devices, the second scheme with extending a reference signal index.

In some embodiments, two threshold numbers (a first threshold number Nₜₕ₂ and a second threshold number Nₜₕ₁, Nₜₕ₁≤Nₜₕ₂) may be defined for comparison with the first number of beams to determine which scheme is chosen. In some embodiments, if the first number of beams is above Nₜₕ₂ (e.g., greater than or equal to Nₜₕ₂), the network device 110 may determine, as the scheme for signal forwarding via the set of repeater devices, the first scheme without extending a reference signal index. In some embodiments, if the first number of beams is below Nₜₕ₁ (e.g., smaller than or equal to Nₜₕ₁), the network device 110 may determine, as the scheme for signal forwarding via the set of repeater devices, the second scheme with extending a reference signal index.

In some embodiments, if the first number of beams is above Nₜₕ₁ (e.g., greater than or equal to Nₜₕ₁) and below Nₜₕ₂ (e.g., smaller than or equal to Nₜₕ₂), the network device 110 may determine the scheme for signal forwarding via the set of repeater devices based on traffic load associated with the network device 110. In some embodiments, if current traffic of the network device 110 is busy, e.g., the current traffic is above threshold traffic, the network device 110 may determine the first scheme as the scheme for signal forwarding via the set of repeater devices. If current traffic of the network device 110 is not busy, e.g., the current traffic is below the threshold traffic, the network device 110 may determine the second scheme as the scheme for signal forwarding via the set of repeater devices.

In some embodiments, if the first number of beams is above Nₜₕ₁ (e.g., greater than or equal to Nₜₕ₁) and below Nₜₕ₂ (e.g., smaller than or equal to Nₜₕ₂), the network device 110 may determine the scheme for signal forwarding via the set of repeater devices based on traffic load associated with one of the set of repeater devices. In some embodiments, the network device 110 may determine the scheme for signal forwarding via the set of repeater devices based on at least one of a number or traffic of severed terminal devices associated with one of the set of repeater devices.

In some embodiments, if the number of the served terminal devices associated with the one of the set of repeater devices is greater than or equal to a threshold number, importance of the repeater device is high and a scheme with a high performance may be adopted. Thus, the network device 110 may determine the second scheme as the scheme for signal forwarding via the repeat device in the set of repeater devices. If the number of the served terminal devices associated with the one of the set of repeater devices is smaller than or equal to the threshold number, importance of the repeater device is low and a scheme with reduce overhead may be adopted. Thus, the network device 110 may determine the first scheme as the scheme for signal forwarding via the repeater device in the set of repeater devices.

In some embodiments, if the traffic of the served terminal devices associated with one of the set of repeater devices is busy, e.g., higher than or equal to a threshold traffic, importance of the repeater device is high and a scheme with a high performance may be adopted. Thus, the network device 110 may determine the second scheme as the scheme for signal forwarding via the repeat device in the set of repeater devices. If the traffic of the served terminal devices associated with one of the set of repeater devices is not busy, e.g., lower than or equal to the threshold traffic, importance of the repeater device is low and a scheme with reduce overhead may be adopted. Thus, the network device 110 may determine the first scheme as the scheme for signal forwarding via the repeater device in the set of repeater devices.

### Embodiment 2

In this embodiment, the network device 110 may receive beam information of a repeater device (e.g., the repeater device 120). In these embodiments, the network device 110 may determine the scheme for signal forwarding via the repeater device 120.

In some embodiments, the network device 110 may determine, from the beam information, a number (for convenience, also referred to as a second number herein) of beams associated with the repeater device 120. In some embodiments, one threshold number (also referred to as a third threshold number herein and denoted as Nₜₕ₋ₙₑᵣ) may be defined for comparison with the second number of beams to determine which scheme is chosen.

If the second number of beams is above Nₜₕ₋ₙₑᵣ, the network device 110 may determine, as the scheme for signal forwarding via the repeater device 120, the first scheme without extending a reference signal index. If the second number of beams is below Nₜₕ₋ₙₑᵣ, the network device 110 may determine, as the scheme for signal forwarding via the repeater device 120, the second scheme with extending a reference signal index.

In some embodiments, a scheme for signal forwarding via a first repeater device is the first scheme and a scheme for signal forwarding via a second repeater device is the second scheme. In these embodiments, if a reference signal transmission via the second repeater device is performed, the network device 110 may transmit, to the first repeater device, an indication indicating turn-off of the first repeater device. In other words, upon transmission of a reference signal related to a NCR which chooses the second scheme, a NCR which chooses the first scheme may turn off its forwarding module. In this way, overhead for signal forwarding and energy may be saved.

### Embodiment 3

In this embodiment, the network device 110 may determine a threshold (for convenience, also referred to as a fourth threshold number herein) for determination of the scheme by the at least one repeater device. In this way, the repeater device 120 may determine the scheme by itself based on the threshold and a number of beams of the repeater device 120, or based on the threshold and a number of beams configured for the repeater device 120.

In some embodiments, the network device 110 may determine the third threshold number Nₜₕ₋ₙₑᵣ described in Embodiment 2 as the fourth threshold number, and indicate Nₜₕ₋ₙₑᵣ to the repeater device 120.

It is to be understood that the first to fourth threshold numbers described above may be determined in any suitable ways.

Continue to FIG. 2, the network device 110 may transmit 230 the information of the scheme to the repeater device 120. Accordingly, the repeater device 120 may determine 240 the scheme based on the received information of the scheme.

In some embodiments, the repeater device 120 may receive an indication of the first scheme without extending a reference signal index. Based on the indication, the repeater device 120 may determine the first scheme as the signal forwarding scheme.

In some embodiments, the repeater device 120 may receive an indication of the second scheme with extending a reference signal index. Based on the indication, the repeater device 120 may determine the second scheme as the signal forwarding scheme.

In some embodiments, the repeater device 120 may receive the fourth threshold number for determination of the scheme by the repeater device 120. In these embodiments, if the number of beams of the repeater device 120 is above the fourth threshold number, the repeater device 120 may determine, as the scheme for signal forwarding via the repeater device 120, the first scheme without extending a reference signal index. If the number of beams of the repeater device 120 is below the fourth threshold number, the repeater device 120 may determine, as the scheme for signal forwarding via the repeater device 120, the second scheme with extending a reference signal index.

Based on the determined scheme, the repeater device 120 may perform 250 signal forwarding. With the process 200, a signal forwarding scheme of a NCR may be flexibly chosen.

Example Implementation of Scheme without Reference Signal Index Extended

For a scheme (i.e., the first scheme) without extending a reference signal index, it is still unclear how to implement reference signal forwarding. In view of this, embodiments of the present disclosure also provide a solution of signal forwarding. The solution will be described with reference to FIG. 3.

FIG. 3 illustrates a schematic diagram illustrating another example process 300 of communication according to some embodiments of the present disclosure. For the purpose of discussion, the process 300 will be described with reference to FIG. 1. The process 300 may involve the network device 110 and the repeater device 120 as illustrated in FIG. 1A. It is to be noted that the process 300 may comprise more additional steps or omit some steps shown, and the present disclosure does not limit the order of the steps.

As shown in FIG. 3, the network device 110 may determine 310 a mapping (for convenience, also referred to as a first mapping herein) between a set of beams (for convenience, also referred to as a set of first beams herein) of the network device 110 for reference signal transmission and a set of beams (for convenience, also referred to as a set of second beams herein) of the repeater device 120 for reference signal forwarding. For example, the set of first beams may comprise the beams 111 to 116, and the set of second beams may comprise the beams 121 to 124.

In some embodiments, the repeater device 120 may transmit 311, to the network device 110, information (for convenience, also referred to as first information herein) of the set of second beams. In some embodiments, the repeater device 120 may transmit the first information directly to the network device 110. In some embodiments, the repeater device 120 may transmit the first information indirectly to the network device 110, e.g., via a higher layer node.

In some embodiments, the first information may comprise information of a beam direction (e.g., boresight) of a second beam (e.g., each second beam) in the set of second beams.

In some embodiments, the first information may comprise information of beam coverage of a second beam (e.g., each second beam) in the set of second beams. For example, the information of beam coverage may comprise coverage (e.g., latitude and longitude) of each access beam for reference signal forwarding. In another example, the coverage may be indexed upon network planning for each network device by considering network environment, and the information of beam coverage may comprise an index of the coverage of each access beam for reference signal forwarding. It is to be understood that the information of beam coverage may comprise any other suitable information.

In some embodiments, the first information may comprise information of interference between a second beam (i.e., Tx beam or access (AC) beam) in the set of second beams and a beam (i.e., Rx beam or backhaul (BH) beam) in a set of beams (for convenience, also referred to as a set of third beams herein) of the repeater device for downlink reference signal reception. For example, the set of second beams may comprise the beams 121 to 124, and the set of third beams may comprise the beams 125 to 126. The interference may be introduced per beam pair {BH #x, AC #y}, e.g., x=0, 1, and y=0, . . . , 3, where BH #x means a backhaul beam with index x; AC #y means an access beam with index y. In some embodiments, the information of the interference may comprise an absolute value of the interference. In some embodiments, the information of the interference may comprise an indication indicating whether the interference is above or below a pre-defined or a pre-configured threshold interference. It is to be understood that the information of the interference may comprise any other suitable information.

In some embodiments, the first information may comprise information of correspondence between a second beam in the set of second beams and a third beam in the set of third beams. For example, in some scenarios of hardware limitations, an Rx beam of the repeater device 120 and a Tx beam of the repeater device 120 may be switched simultaneously without additional delay or with a shortest delay. In another example, in some scenarios of best radiation performance, a Tx beam of the repeater device 120 may have a best total radiation intensity for a given Rx beam of the repeater device 120. It is to be understood that the correspondence between a Tx beam and a Rx beam may be determined based on any other suitable factors.

It is to be understood that the first information may comprise any combination of the above information and any other suitable information.

Based on the first information, the network device 110 may determine 312 the first mapping. In some embodiments where the first information comprises the information of a beam direction (e.g., boresight) of each second beam in the set of second beams, the network device 110 may map, to a Tx beam of the network device 110, a Tx beam of the repeater device 120 whose boresight direction is nearest to that of the Tx beam of the network device 110. In this way, the network device 110 may determine the first mapping based on the information of the beam direction.

In some embodiments where the first information may comprise the information of beam coverage of a second beam in the set of second beams, the network device 110 may map, to a Tx beam of the network device 110, a Tx beam of the repeater device 120 whose coverage maximally overlapped with that of the Rx beam of the network device 110.

It is assumed that the Tx beams 111 to 116 of the network device 110 correspond to SSB indexes #0 to #5, and the Tx beams 121 to 124 of the repeater device 120 correspond to AC beams #0 to #3. In some embodiments, for a Tx beam (e.g., a Tx beam associated with SSB #0 or SSB #1) of the network device 110 whose coverage is not blocked or is not overlapped with coverage of any Tx beams of the repeater device 120, no mapping is built for the Tx beam of the network device 110. In some embodiments, the repeater device 120 may turn off the forwarding module when a reference signal is transmitted from such Tx beam of the network device 110.

Alternatively, for the Tx beam (e.g., a Tx beam associated with SSB #0 or SSB #1) of the network device 110 whose coverage is not blocked or is not overlapped with coverage of any Tx beams of the repeater device 120, a mapping of another Tx beam nearest to the Tx beam may be chosen for the Tx beam. For example, AC #0 is a Tx beam of the repeater device 120 associated with a Tx beam of the network device 110 for SSB #2. Thus, AC #0 may be chosen for both SSB #0 and SSB #1 in the mapping. In this way, the network device 110 may determine the first mapping based on the information of the beam coverage.

It is assumed that the Tx beams 111 to 116 of the network device 110 correspond to SSB indexes #0 to #5, and the Rx beams 125 to 126 of the repeater device 120 correspond to BH beams #0 to #1. In some embodiments where the first information may comprise the information of interference between a Tx beam and a Rx beam of the repeater device 120, the network device 110 may not map, to a Tx beam of the network device 110, a Tx beam of the repeater device 120 which introduces interference to a Rx beam associated with the Tx beam of the network device 110. For example, for SSB #0, the best Rx beam of the repeater device 120 is BH #0, and a nominal Tx beam of the repeater device 120 associated with SSB #0 initially determined via previous methods is AC #0. However, AC #0 introduces too much interference to BH #0. Thus, AC #0 may not be mapped to SSB #0 for the first mapping. A neighbor Tx beam AC #1 of the repeater device 120 may be chosen for a mapping of SSB #0 if the interference introduced to BH #0 by AC #1 is below a predefined or pre-configured threshold.

In some embodiments where the first information may comprise the information of correspondence between a Tx beam and a Rx beam of the repeater device 120, the network device 110 may determine which Tx beam of the repeater device 120 is the best for measured reference signals based on the information of the correspondence.

It is to be understood that the network device 110 may determine the first mapping based on any combination of the above criterions.

In some embodiments for the first mapping, the network device 110 may associate a first beam in the set of first beams with a second beam in the set of second beams. In other words, one Tx beam of the network device 110 may map to one Tx beam of the repeater device 120, and different Tx beams of network device 110 may map to a same Tx beam of the repeater device 120. For example, assuming that the Tx beams 111 to 116 of the network device 110 correspond to SSB indexes #0 to #5, and the Tx beams 121 to 124 of the repeater device 120 correspond to AC beams #0 to #3. The mapping may be represented as beam pairs {SSB #0, AC #0}, {SSB #1, AC #0}, {SSB #2, AC #1}, {SSB #3, AC #1}, {SSB #4, AC #2}, {SSB #5, AC #3}. For a beam pair, an access beam AC #x in the beam pair is used to forward SSB #y in the beam pair.

In some embodiments, a number of Tx beams of the network device 110 mapped to each Tx beam of the repeater device 120 may be the same. In this way, Tx beams of the network device 110 and Tx beams of the repeater device 120 are uniformly distributed. In some embodiments, a number of Tx beams of the network device 110 mapped to each Tx beam of the repeater device 120 may be different. In this way, Tx beams of the network device 110 and Tx beams of the repeater device 120 are non-uniformly distributed.

In some embodiments for the first mapping, the network device 110 may associate a second beam in the set of second beams with a subset of first beams in the set of first beams. In other words, one Tx beam of the repeater device 120 may map to one or more Tx beams of the network device 110. For example, the mapping may be represented as shown in Table 1 below.

TABLE 1

| Access Beam | SSB Index |
|---|---|
| #0 | #0, #1 |
| #1 | #2, #3 |
| #2 | #4 |
| #3 | #5 |

It is to be understood that the first mapping may adopt any other suitable forms, and the present disclosure does not limit this aspect.

Continue to refer to FIG. 3, the network device 110 may transmit 320 the first mapping to the repeater device 120.

In some embodiments, the network device 110 may determine a further mapping (for convenience, also referred to as a third mapping herein) between the set of first beams of the network device 110 for further reference signal transmission and the set of second beams of the repeater device 120 for further reference signal forwarding. The network device 110 may transmit the third mapping to the repeater device 120. In other words, different mappings may be determined for different reference signal transmissions. For example, different mappings may be determined for SSB transmission and CSI-RS transmission.

Alternatively, the repeater device 120 may determine 330 the first mapping by itself. In this case, the network device 110 may not configure the first mapping to the repeater device 120. In some embodiments, based on the information of the correspondence between a Tx beam and a Rx beam of the repeater device 120, the repeater device 120 may directly determine a Tx beam of the repeater device 120 from the information of the correspondence based on an used Rx beam of the repeater device 120 for reception of a given reference signal index. The repeater device 120 may determine the first mapping by associating a Tx beam of the network device 110 with a Tx beam of the repeater device 120 or associating a Tx beam of the repeater device 120 with one or more Tx beams of the network device 110.

Continue to refer to FIG. 3, the repeater device 120 may perform 340 reference signal forwarding based on the first mapping. In some embodiments, the repeater device 120 may perform 341 channel measurements for a set of beam pairs formed by the set of first beams (i.e., Tx beams of the network device 110) and a set of third beams of the repeater device 120 for reference signal reception (i.e., BH or Rx beams of the repeater device 120).

In some embodiments, the repeater device 120 may use a legacy beam management procedure to perform the channel measurements. In the legacy beam management procedure, in a time period 1, the channel measurements may be performed in the case that the network device 110 may switch Tx beams and the repeater device 120 may fix at Rx beam #0. In a time period 2, the channel measurements may be performed in the case that the network device 110 may switch Tx beams and the repeater device 120 may fix at Rx beam #1. In a time period M, the channel measurements may be performed in the case that the network device 110 may switch Tx beams and the repeater device 120 may fix at Rx beam #M−1. In this way, measured values may be obtained as shown in Table 2 below. Here, a number of Tx beams of the network device 110 for SSB transmission is N, and a number of Rx beams of the repeater device 120 for SSB reception is M.

TABLE 2

| | SSB#0 | SSB#1 | . . . | SSB#N − 1 |
|---|---|---|---|---|
| Period 1 | RSRP_0_0 | RSRP_0_1 | . . . | RSRP_0_N − 1 |
| Period 2 | RSRP_1_0 | RSRP_1_1 | . . . | RSRP_1_N − 1 |
| . . . | . . . | . . . | . . . | . . . |
| Period M | RSRP_M_0 | RSRP_M_1 | . . . | RSRP_M_N − 1 |

In some embodiments, the repeater device 120 may use a dedicated beam management procedure to perform the channel measurements. In the dedicated beam management procedure, in a time 0, the channel measurements may be performed in the case that the network device 110 may fix at a Tx beam related to SSB #0, and the repeater device 120 may switch Rx beams. In a time 1, the channel measurements may be performed in the case that the network device 110 may fix at a Tx beam related to SSB #1, and the repeater device 120 may switch Rx beams. In time N−1, the channel measurements may be performed in the case that the network device 110 may fix at a Tx beam related to SSB #N−1, and the repeater device 120 may switch Rx beams. In this way, measured values may be obtained as shown in Table 3 below. Here, a number of Tx beams of the network device 110 for SSB transmission is N, and a number of Rx beams of the repeater device 120 for SSB reception is M.

TABLE 3

| | | | | |
|---|---|---|---|---|
| Time 0 & | RSRP_0_0 | RSRP_1_0 | | RSRP_M − |
| SSB#0 | | | | 1_0 |
| Time 1 & | RSRP_0_1 | RSRP_1_1 | . . . | RSRP_M − |
| SSB#1 | | | | 1_1 |
| . . . | . . . | . . . | . . . | . . . |
| Time N − 1 & | RSRP_0_N − 1 | RSRP_1_N − 1 | . . . | RSRP_M − |
| SSB#N − 1 | | | | 1_N − 1 |

Continue to refer to FIG. 3, the repeater device 120 may transmit 342 the channel measurements for the set of beam pairs. In some embodiments, the repeater device 120 may transmit a measured value associated with a beam pair in the set of beam pairs. The beam pair is composed of a BH beam of the repeater device 120 and a Tx beam of the network device 110. The measured value is above a threshold value (for convenience, also referred to as a first threshold value herein). In the example of Table 2, the repeater device 120 may compare measurements among different Rx beams for a same Tx beam of the network device 110 and report a maximum measured value among the measurements for the Tx beam. In the example of Table 3, the repeater device 120 may directly report a maximum measured value for each Tx beam associated with one SSB index of the network device 110.

In some embodiments, the repeater device 120 may transmit information of a third beam (i.e., Rx beam of the repeater device 120) in the set of third beams, the third beam being associated with a first beam (i.e., Tx beam of the network device 110) in the set of first beams. In some embodiments, the information of the third beam may comprise an index of an Rx beam of the repeater device 120. In some embodiments, the information of the third beam may comprise an index of transmission configuration indicator (TCI) state related to the Rx beam. In some embodiments, the information of the third beam may comprise a reference signal index (e.g., SSB index) related to the Rx beam.

In some embodiments, for SSB #x, there may be no measured value above the first threshold value. In these embodiments, the repeater device 120 may transmit an indication of absence of the third beam associated with the first beam. That is, a special state is reported. In this case, the repeater device 120 may turn off the forwarding module when the corresponding SSB #x is transmitted.

Continue to FIG. 3, based on the channel measurements, the network device 110 may determine 350 a mapping (for convenience, also referred to as a second mapping herein) between a first beam (i.e., Tx beam of the network device 110) in the set of first beams and a third beam (i.e., Rx beam of the repeater device 120) in the set of third beams. For example, the network device 110 may determine the best Rx beam of the repeater device 120 for each reference signal index based on the channel measurements.

The network device 110 may transmit 360 the second mapping to the repeater device 120. Based on the second mapping, the repeater device 120 may receive a reference signal from the network device 110. Based on the first mapping, the repeater device 120 may use an associated access beam to forward the reference signal to the terminal device 130.

Continue to refer to FIG. 3, in some embodiments, the network device 110 may also determine 370 transmission power associated with a beam pair in the set of beam pairs. The beam pair is composed of a BH beam of the repeater device 120 and a Tx beam of the network device 110. In some embodiments, the network device 110 may determine a reference measured value from a set of measured values associated with the set of beam pairs, the reference measured value being above a threshold value (for convenience, also referred to as a second threshold value herein). In some embodiments, the network device 110 may determine, as the reference measured value, a maximum measured value among the set of measured values. It is to be understood that the reference measured value may also be determined in any other suitable ways.

The reference measured value is associated with a further beam pair. Then the network device 110 may determine reference transmission power for a second beam associated with a first beam in the further beam pair according to the first mapping. The network device 110 may determine the transmission power for a second beam associated with the beam pair at least based on the reference transmission power, the reference measured value, and a measured value associated with the beam pair. In some embodiments, power offset may be defined as difference between a reported value and a reported maximum value. For example, the transmission power may be determined based on equation (1) below.

$$P = P 0 + P max r - Pm \qquad ( 1 )$$

where P denotes transmission power for a second beam associated with a beam pair {SSB #m, BH #q}, P0 denotes the reference transmission power for AC #x associated with beam pair {SSB #n, BH #y}, Pmaxr denotes the reference measured value associated with {SSB #n, BH #y, AC #x}, and Pm denotes a measured value associated with the beam pair {SSB #m, BH #q}.

In another example, the transmission power may be determined based on equation (2) below.

$$P = min \{ P 0 + P max r - Pm , P max \} \qquad ( 2 )$$

where P denotes transmission power for a second beam associated with a beam pair {SSB #m, BH #q}, P0 denotes the reference transmission power for AC #x associated with beam pair {SSB #n, BH #y}, Pmaxr denotes the reference measured value associated with {SSB #n, BH #y, AC #x}, Pm denotes a measured value associated with the beam pair {SSB #m, BH #q}, and Pmax denotes maximum transmission power of the repeater device 120.

It is to be understood that equations (1) and (2) are merely for illustration, and any other suitable forms are also feasible.

Continue to refer to FIG. 3, the network device 110 may transmit 380 the transmission power associated with the beam pair to the repeater device 120. The repeater device 120 may perform, based on the transmission power, reference signal forwarding via a Tx beam of the repeater device 120 associated with a Tx beam of the network device 110 in the beam pair.

With reference to FIG. 3, in some embodiments, the repeater device 120 may receive 390 a physical random access channel (PRACH) signal from the terminal device 130 in a time-frequency location (for convenience, also referred to as a first time-frequency location herein). The repeater device 120 may transmit 395 the PRACH signal to the network device 110 in another time-frequency location (for convenience, also referred to as a second time-frequency location herein) configured for the repeater device 120.

In some embodiments, the second time-frequency location may have a predetermined offset (for convenience, also referred to as a first predetermined offset herein) with respect to the first time-frequency location in frequency domain. In some embodiments, the first time-frequency location may be shifted within a same bandwidth part (BWP). In some embodiments where a bandwidth for the PRACH signal is taken as a reference, the shifted bandwidth may be larger than a predefined number (denoted as N_RB) of physical resource blocks (PRBs). In some embodiments where multiple repeater devices are associated with the network device 110, the shifted bandwidth for different repeater devices may be different. For example, the shifted bandwidth may be determined based on equation (3) below.

$$B = ID * N\_RB \qquad ( 3 )$$

where B denotes the shifted bandwidth, ID denotes an identity of a repeater device, and N_RB denotes the predefined number of PRBs. ID is defined within the coverage of the network device 110.

In some embodiments, the first time-frequency location may be shifted to a dedicated BWP or a dedicated resource or a dedicated band. In this way, interference to other UEs may be avoided. In some embodiments, different dedicated resources may be indicated for each repeater device.

In some embodiments, a bandwidth may be the same as that of a PRACH resource for normal UE. In some embodiments, time duration may be the same as that of a PRACH resource for normal UE. In some embodiments, a dedicated resource for a repeater device may be associated with an identity of the repeater device within the coverage of a network device. For example, dedicated resource band indexes may be predefined. In another example, a mapping between a band index and an identity of a repeater device may be predefined. The dedicated resource band may be determined based on the identity of the repeater device and the mapping implicitly. If no mapping is indicated, a default mapping may be used.

In some embodiments, the second time-frequency location may have a predetermined offset (for convenience, also referred to as a second predetermined offset herein) with respect to the first time-frequency location in time domain. In some embodiments, a dedicated time window may be applied to the repeater device 120 for forward a reference signal transmitted from the terminal device 130. In this way, interference to other UEs may be avoided. In some embodiments, different offsets for the dedicated time window may be defined or configured for different repeater devices.

In some embodiments, the offsets may be within a reference signal transmission period. In some embodiments, the offsets may be in terms of 0.625 ms or 1.25 ms. An offset for a repeater device may be determined by ID* 0.625 ms or ID * 1.25 ms. ID denotes an identity of the repeater device and is defined within the coverage of a network device. It is to be understood that other mapping within the reference signal transmission period may also be feasible. For example, an offset for a repeater device may be determined by ID* N* 0.625 ms or ID *N* 1.25 ms. N is an integer equal to or greater than 1, which can be pre-defined or pre-configured. In another example, a mapping between x-th time window and γ-th repeater device may be predefined or configured. In some embodiments, a same duration may be designed for dedicated time windows of all the repeater devices.

Accordingly, the network device 110 may receive a PRACH signal in a time-frequency location configured for the repeater device 120.

With the process 300, a signal forwarding scheme without extending a reference signal index may be achieved.

### Example Implementation of Application Time of Beam Mapping

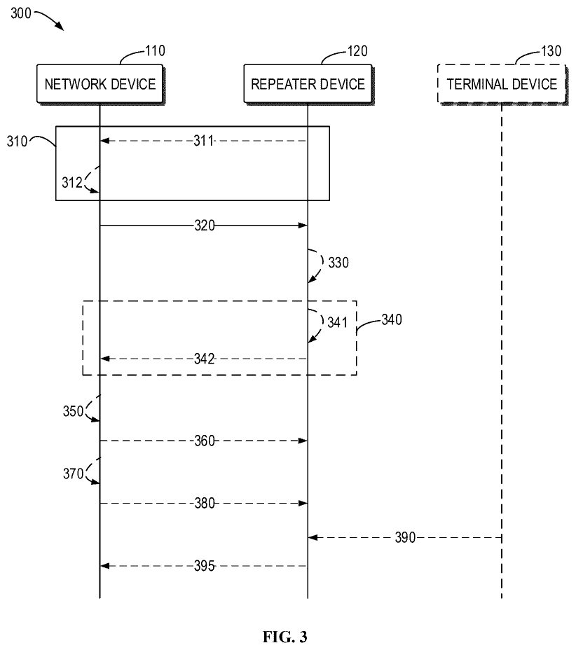

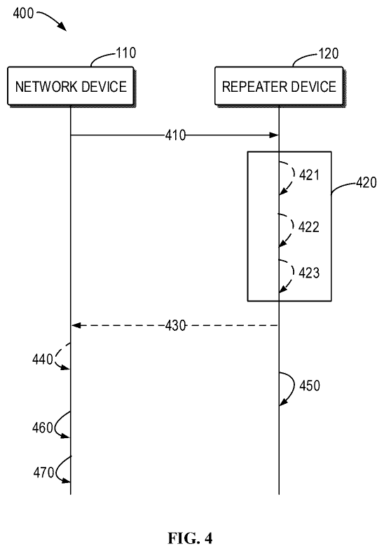

In a scheme (i.e., the first scheme) without extending a reference signal index, an application time of a mapping (i.e., the first mapping) between a Tx beam of a network device and a Tx beam of a repeater device needs to be clarified. Embodiments of the present disclosure provide a solution of determining the application time. The solution will be described with reference to FIG. 4.

FIG. 4 illustrates a schematic diagram illustrating still another example process 400 of communication according to some embodiments of the present disclosure. For the purpose of discussion, the process 400 will be described with reference to FIG. 1. The process 400 may involve the network device 110 and the repeater device 120 as illustrated in FIG. 1A. It is to be noted that the process 400 may comprise more additional steps or omit some steps shown, and the present disclosure does not limit the order of the steps.

As shown in FIG. 4, the network device 110 may transmit 410, to the repeater device 120, a mapping (i.e., the first mapping) between a set of first beams (i.e., Tx beams) of the network device 110 for reference signal transmission and a set of second beams (i.e., Tx beams) of the repeater device 120 for reference signal forwarding.

The repeater device 120 may determine 420 an application time of the mapping. In some embodiments, the repeater device 120 may determine 421 a reference time based on a time of the receiving of the mapping and a signaling processing time of the repeater device 120. For example, the reference time may be determined based on equation (4) below.

$$t 2 = t 0 + t\_proc \qquad ( 4 )$$

where t2 denotes the reference time, to denotes the time of the receiving of the mapping, and t_proc denotes the signaling processing time of the repeater device 120. In some embodiments, t_proc may comprise the time between the time of receiving the first mapping and the time at which a feedback for the first mapping is received successfully by repeater device. It is to be understood that equation (4) is merely an example, and any other suitable forms are also feasible.

Upon determination of the reference time, the repeater device 120 may determine 422 a time offset (denoted as t_offset) based on the reference time and an occasion of reference signal transmission. Then the repeater device 120 may determine 423 the application time of the mapping based on the time offset and the time of the receiving of the mapping. For illustration, some example embodiments will be described in connection with Embodiments 4 to 6 below.

### Embodiment 4

In this embodiment, it is assumed that the occasion starts before the reference time and ends after the reference time. An occasion used herein refers to a whole duration within a period for reference signal transmitting or forwarding or receiving on a repeater device, which is from the transmitting time or forwarding time or receiving time of the first reference signal, to the transmitting time or forwarding time or receiving time of the last reference signal.

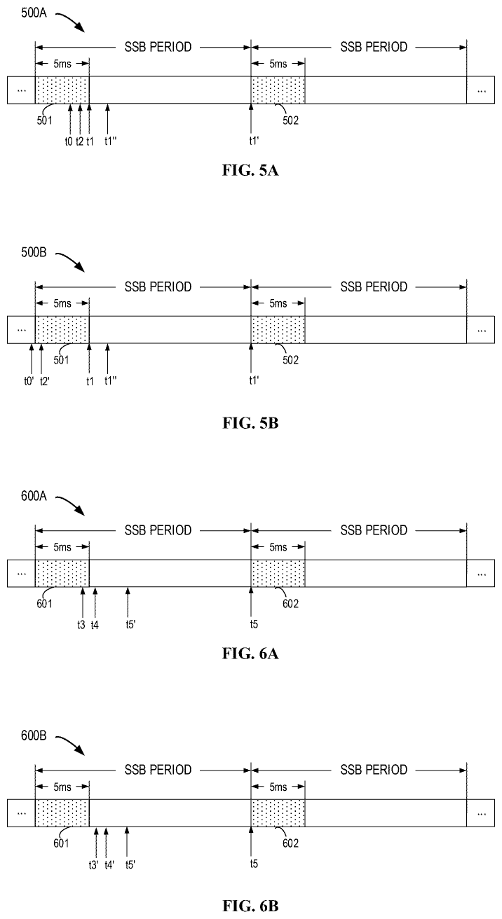

In some embodiments, the repeater device 120 may determine, as the time offset, a time gap between the time of the receiving of the mapping and an ending edge of the occasion. FIG. 5A illustrates a schematic diagram 500A illustrating an example determination of an application time of a mapping between Tx beams of a network device and Tx beams of a NCR according to some embodiments of the present disclosure. As shown in FIG. 5A, the mapping is received at time to which is within an occasion 501 of reference signal transmission. Then a reference time t2 is determined from t0 and the signaling processing time of the repeater device 120 based on the above equation (4). The reference time t2 is within the occasion 501. Then a time gap between t0 and an ending edge t1 of the occasion 501 is determined as the time offset with respect to t0. Thus, the application time of the mapping may be determined as the ending edge t1 of the occasion 501.

FIG. 5B illustrates a schematic diagram 500B illustrating another example determination of an application time of a mapping between Tx beams of a network device and Tx beams of a NCR according to some embodiments of the present disclosure. As shown in FIG. 5B, the mapping is received at time to′ which is before the occasion 501 of reference signal transmission. Then a reference time t2′ is determined from t0′ and the signaling processing time of the repeater device 120 based on the above equation (4). The reference time t2′ is within the occasion 501. Then a time gap between t0′ and an ending edge t1 of the occasion 501 is determined as the time offset with respect to t0′. Thus, the application time of the mapping may be determined as the ending edge t1 of the occasion 501.

In some embodiments, the repeater device 120 may determine, as the time offset, a time gap between the time of the receiving of the mapping and a starting edge of a further occasion of reference signal transmission, the further occasion being later than the occasion. In some embodiments, the further occasion is the next occasion of reference signal transmission. It is to be understood that other later occasions may also be feasible. Continue to refer to FIG. 5A, the mapping is received at timing to which is within the occasion 501 of reference signal transmission. Then the reference time t2 is determined from t0′ and the signaling processing time of the repeater device 120 based on the above equation (4). The reference time t2 is within the occasion 501. Then a time gap between t0 and a starting edge t1′ of the occasion 502 is determined as the time offset with respect to t0. Thus, the application time of the mapping may be determined as the starting edge t1′ of the occasion 502.

Continue to refer to FIG. 5B, the mapping is received at time to′ which is before the occasion 501 of reference signal transmission. Then a reference time t2′ is determined from t0′ and the signaling processing time of the repeater device 120 based on the above equation (4). The reference time t2′ is within the occasion 501. Then a time gap between t0′ and a starting edge t1′ of the occasion 502 is determined as the time offset with respect to t0′. Thus, the application time of the mapping may be determined as the starting edge t1′ of the occasion 502.

In some embodiments, the repeater device 120 may determine, as the time offset, a time gap between the time of the receiving of the mapping and a time of receiving a feedback from the terminal device 130 for a predetermined reference signal transmission related to the occasion. In some embodiments, the predetermined reference signal transmission may be the last reference signal transmission on the occasion. It is to be understood that other reference signal transmissions on the occasion may also be feasible. Continue to refer to FIG. 5A, the mapping is received at time to which occurs before the occasion 501 of reference signal transmission. Then the reference time t2 is determined from t0′ and the signaling processing time of the repeater device 120 based on the above equation (4). The reference time t2 is within the occasion 501. It is assumed that the repeater device 120 receives, at a time t1″ and from the terminal device 130, a feedback for the last reference signal transmission on the occasion 501. Thus, a time gap between to and the time t1″ is determined as the time offset with respect to t0. Thus, the application time of the mapping may be determined as the time t1″.

Continue to refer to FIG. 5B, the mapping is received at time to′ which is before the occasion 501 of reference signal transmission. Then a reference time t2′ is determined from t0′ and the signaling processing time of the repeater device 120 based on the above equation (4). The reference time t2′ is within the occasion 501. It is assumed that the repeater device 120 receives, at a time t1″ and from the terminal device 130, a feedback for the last reference signal transmission on the occasion 501. Thus, a time gap between to′ and the time t1″ is determined as the time offset with respect to t0′. Thus, the application time of the mapping may be determined as the time t1″.

### Embodiment 5

In this embodiment, it is assumed that the occasion ends before the reference time and a further occasion (e.g., the next occasion) of reference signal transmission starts after the reference time.

In some embodiments, the repeater device 120 may determine, as the time offset, the signaling processing time of the repeater device 120. FIG. 6A illustrates a schematic diagram 600A illustrating another example determination of an application time of a mapping between Tx beams of a network device and Tx beams of a NCR according to some embodiments of the present disclosure. As shown in FIG. 6A, the mapping is received at time t3 which is within an occasion 601 of reference signal transmission. Then a reference time t4 is determined from t3 and the signaling processing time of the repeater device 120 based on the above equation (4). The reference time t4 is after the ending time of the occasion 601 and before the starting time of the occasion 602. Then the signal processing time of the repeater device 120 is determined as the time offset with respect to t3. Thus, the application time of the mapping may be determined as the reference time t4.

FIG. 6B illustrates a schematic diagram 600B illustrating another example determination of an application time of a mapping between Tx beams of a network device and Tx beams of a NCR according to some embodiments of the present disclosure. As shown in FIG. 6B, the mapping is received at time t3′ which is after the ending time of the occasion 601 and before the starting time of the occasion 602. Then a reference time t4′ is determined from t3′ and the signaling processing time of the repeater device 120 based on the above equation (4). The reference time t4′ is after the ending time of the occasion 601 and before the starting time of the occasion 602. Then the signal processing time of the repeater device 120 is determined as the time offset with respect to t3′. Thus, the application time of the mapping may be determined as the reference time t4′.

In some embodiments, the repeater device 120 may determine, as the time offset, a time gap between the time of the receiving of the mapping and a starting edge of the further occasion. In some embodiments, the further occasion is the next occasion of reference signal transmission. It is to be understood that other later occasions may also be feasible. Continue to refer to FIG. 6A, the mapping is received at timing t3 which is within the occasion 601 of reference signal transmission. Then the reference time t4 is determined from t3 and the signaling processing time of the repeater device 120 based on the above equation (4). The reference time t4 is after the ending time of the occasion 601 and before the starting time of the occasion 602. Then a time gap between t3 and a starting edge t5 of the occasion 602 is determined as the time offset with respect to t3. Thus, the application time of the mapping may be determined as the starting edge t5 of the occasion 602.

Continue to refer to FIG. 6B, the mapping is received at time t3′ which is after the ending time of the occasion 601 of reference signal transmission, and before the starting time of the occasion 602 . . . . Then a reference time t4′ is determined from t3′ and the signaling processing time of the repeater device 120 based on the above equation (4). The reference time t4′ is after the ending time of the occasion 601 and before the starting time of the occasion 602. Then a time gap between t3′ and a starting edge t5 of the occasion 602 is determined as the time offset with respect to t3′. Thus, the application time of the mapping may be determined as the starting edge t5 of the occasion 502.

In some embodiments, the repeater device 120 may determine, as the time offset, a time gap between the time of the receiving of the mapping and a time of receiving a feedback from the terminal device 130 for a predetermined reference signal transmission related to the occasion. In some embodiments, the predetermined reference signal transmission may be the last reference signal transmission on the occasion. It is to be understood that other reference signal transmissions on the occasion may also be feasible. Continue to refer to FIG. 6A, the mapping is received at time t3 which is within the occasion 601 of reference signal transmission. Then the reference time t4 is determined from t3 and the signaling processing time of the repeater device 120 based on the above equation (4). The reference time t4 is after the ending time of the occasion 601 and before the starting time of the occasion 602. It is assumed that the repeater device 120 receives, at a time t5′ and from the terminal device 130, a feedback for the last reference signal transmission on the occasion 501. Thus, a time gap between t3 and the time t5′ is determined as the time offset with respect to t3. Thus, the application time of the mapping may be determined as the time t5′.

Continue to refer to FIG. 6B, the mapping is received at time t3′ which is after the ending time of the occasion 601 of reference signal transmission, and before the starting time of . . . . Then a reference time t4′ is determined from t3′ and the signaling processing time of the repeater device 120 based on the above equation (4). The reference time t4′ is after the ending time of the occasion 601 and before the ending time of the occasion 602.

It is assumed that the repeater device 120 receives, at a time t5′ and from the terminal device 130, a feedback for the last reference signal transmission on the occasion 501. Thus, a time gap between t3′ and the time t5′ is determined as the time offset with respect to t3′. Thus, the application time of the mapping may be determined as the time t5′.

### Embodiment 6

In this embodiment, the time offset is determined as zero. That is, the reference time is determined as the application time of the mapping.

Continue to refer to FIG. 4, in some embodiments, if the occasion starts before the reference time and ends after the reference time (that is, the reference time is within the occasion), the repeater device 120 may transmit 430 information of the reference time to the network device 110.

The network device 110 may discard 440 at least a part of measurements associated with the occasion for the terminal device 130 associated with the repeater device 120. In some embodiments, the network device 110 may discard a part (for convenience, also referred to as a first part herein) of the measurements associated with a portion (for convenience, also referred to as a first portion herein) of the occasion between the reference time and an ending edge of the occasion. In some embodiments, the network device 110 may discard a part (for convenience, also referred to as a second part herein) of the measurements associated with a portion (for convenience, also referred to as a second portion herein) of the occasion between a starting edge of the occasion and the reference time. In some embodiments, the network device 110 may discard a smaller one of the first part and the second part.

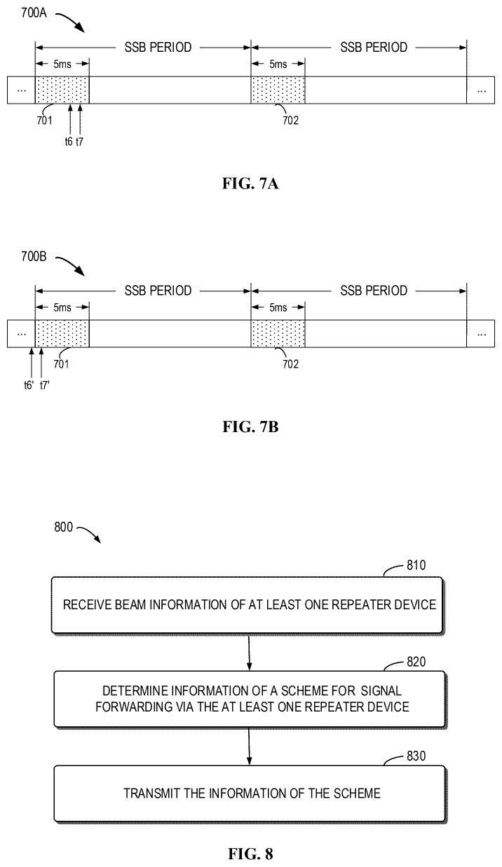

FIG. 7A illustrates a schematic diagram 700A illustrating another example determination of an application time of a mapping between Tx beams of a network device and Tx beams of a NCR according to some embodiments of the present disclosure. As shown in FIG. 7A, the mapping is received at time t6 which is within an occasion 701 of reference signal transmission. Then a reference time t7 is determined from t6 and the signaling processing time of the repeater device 120 based on the above equation (4). The reference time t7 is within the occasion 701. Thus, the application time of the mapping may be determined as the reference time t7. The network device 110 may discard the part of the measurements associated with the portion of the occasion 701 between the reference time t7 and the ending edge of the occasion 701.

FIG. 7B illustrates a schematic diagram 700B illustrating another example determination of an application time of a mapping between Tx beams of a network device and Tx beams of a NCR according to some embodiments of the present disclosure. As shown in FIG. 7B, the mapping is received at time t6′ which is before the starting time of the occasion 701 of reference signal transmission. Then a reference time t7′ is determined from t6′ and the signaling processing time of the repeater device 120 based on the above equation (4). The reference time t7′ is within the occasion 701. Thus, the application time of the mapping may be determined as the reference time t7′. The network device 110 may discard the part of the measurements associated with the portion of the occasion 701 between the starting edge of the occasion 701 and the reference time t7′. It is to be understood that FIGS. 7A and 7B are merely examples, and the present disclosure is not limited to them.

Continue to refer to FIG. 4, upon determination of the application time of the mapping, the repeater device 120 may apply 450, based on the application time, the mapping for the reference signal forwarding. For example, the repeater device 120 may receive a reference signal from a Tx beam of the network device 110. Based on the mapping, the repeater device 120 may determine a Tx beam of the repeater device 120 corresponding to the Tx beam of the network device 110. Then the repeater device 120 may forward the reference signal to the terminal device 130 via the determined Tx beam of the repeater device 120.

Similarly, the network device 110 may also determine 460 the application time of the mapping. In some embodiments, the network device 110 may determine a reference time based on a time of the transmitting of the mapping and a signaling processing time of the repeater device 120. Then the network device 110 may determine a time offset based on the reference time and an occasion of reference signal transmission, and determine the application time based on the time of the transmitting of the mapping and the time offset.

In some embodiments, the occasion may start before the reference time and end after the reference time. In these embodiments, the network device 110 may determine, as the time offset, a time gap between the time of the transmitting of the mapping and an ending edge of the occasion. In some alternative embodiments, the network device 110 may determine, as the time offset, a time gap between the time of the transmitting of the mapping and a starting edge of a further occasion of reference signal transmission, the further occasion being later than the occasion. In some alternative embodiments, the network device 110 may determine, as the time offset, a time gap between the time of the transmitting of the mapping and a time of receiving a feedback from the terminal device 130 for a predetermined reference signal transmission related to the occasion.

In some embodiments, the occasion may end before the reference time and a further occasion of reference signal transmission may start after the reference time. In these embodiments, the network device 110 may determine, as the time offset, the signaling processing time of the repeater device 120. In some alternative embodiments, the network device 110 may determine, as the time offset, a time gap between the time of the transmitting of the mapping and a starting edge of the further occasion. In some alternative embodiments, the network device 110 may determine, as the time offset, a time gap between the time of the transmitting of the mapping and a time of receiving a feedback from the terminal device 130 for a predetermined reference signal transmission related to the occasion.

It is to be understood that the determination of the application time of the mapping at the network device 110 is similar to that at the repeater device 120, and thus other details are not repeated here for concise.

With reference to FIG. 4, based on the determined application time, the network device 110 may apply 470 the mapping for reception of a feedback for the reference signal transmission.

It is to be understood that any of solutions described above may be used separately or in any suitable combination.

### Example Implementation of Methods

Accordingly, embodiments of the present disclosure provide methods of communication implemented at a network device, a repeater device and a terminal device. These methods will be described below with reference to FIGS. 8 to 13.

FIG. 8 illustrates an example method 800 of communication implemented at a network device in accordance with some embodiments of the present disclosure. For example, the method 800 may be performed at the network device 110 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the network device 110 receives, from at least one repeater device in a set of repeater devices, beam information of the at least one repeater device.

At block 820, the network device 110 determines, based on the beam information, information of a scheme for signal forwarding via the at least one repeater device.

In some embodiments, the network device 110 may determine, from the beam information, a first number of beams associated with the set of repeater devices. If the first number of beams is above a first threshold number, the network device 110 may determine, as the scheme for signal forwarding via the set of repeater devices, a first scheme without extending a reference signal index. If the first number of beams is below a second threshold number, the network device 110 may determine, as the scheme for signal forwarding via the set of repeater devices, a second scheme with extending a reference signal index.

In some embodiments, the first threshold number may be equal to or greater than the second threshold number.

In some embodiments where the first threshold number is greater than the second threshold number, if the first number of beams is below the first threshold number and is above the second threshold number, the network device 110 may determine, based on a traffic load associated with the network device or the at least one repeater device, the scheme for signal forwarding via the at least one repeater device.

In some embodiments, the at least one repeater device may comprise a repeater device. In these embodiments, the network device 110 may determine, from the beam information, a second number of beams associated with the repeater device. If the second number of beams is above a third threshold number, the network device 110 may determine, as the scheme for signal forwarding via the repeater device, a first scheme without extending a reference signal index. If the second number of beams is below the third threshold number, the network device 110 may determine, as the scheme for signal forwarding via the repeater device, a second scheme with extending a reference signal index.

In some embodiments, a scheme for signal forwarding via a first repeater device is the first scheme and a scheme for signal forwarding via a second repeater device is the second scheme. In these embodiments, if a reference signal transmission via the second repeater device is performed, the network device 110 may transmit, to the first repeater device, an indication indicating turn-off of the first repeater device.

In some embodiments, the network device 110 may determine, from the beam information, a fourth threshold number for determination of the scheme by the at least one repeater device.

At block 830, the network device 110 transmits the information of the scheme to the at least one repeater device.

With the method 800, a signal forwarding scheme of a NCR may be flexibly determined.

FIG. 9 illustrates an example method 900 of communication implemented at a repeater device in accordance with some embodiments of the present disclosure. For example, the method 900 may be performed at the repeater device 120 as shown in FIG. 1A. For the purpose of discussion, in the following, the method 900 will be described with reference to FIG. 1A. It is to be understood that the method 900 may include additional blocks not shown and/or may omit some blocks as shown, and the scope of the present disclosure is not limited in this regard.

At block 910, the repeater device 120 transmits, to the network device 110, beam information of the repeater device 120.

At block 920, the repeater device 120 receives, from the network device 110, information of a scheme for signal forwarding via the repeater device 120.

In some embodiments, the repeater device 120 may receive an indication of a first scheme without extending a reference signal index. In some embodiments, the repeater device 120 may receive an indication of a second scheme with extending a reference signal index.

In some embodiments, the repeater device 120 may receive, from the network device, a fourth threshold number for determination of the scheme by the repeater device 120. In some embodiments, if a number of beams of the repeater device is above the fourth threshold number, the repeater device 120 may determine, as the scheme for signal forwarding via the repeater device 120, a first scheme without extending a reference signal index. If the number of beams of the repeater device is below the fourth threshold number, the repeater device 120 may determine, as the scheme for signal forwarding via the repeater device, a second scheme with extending a reference signal index.

At block 930, the repeater device 120 performs signal forwarding based on the scheme.

With the method 900, a NCR may flexibly use different signal forwarding schemes.

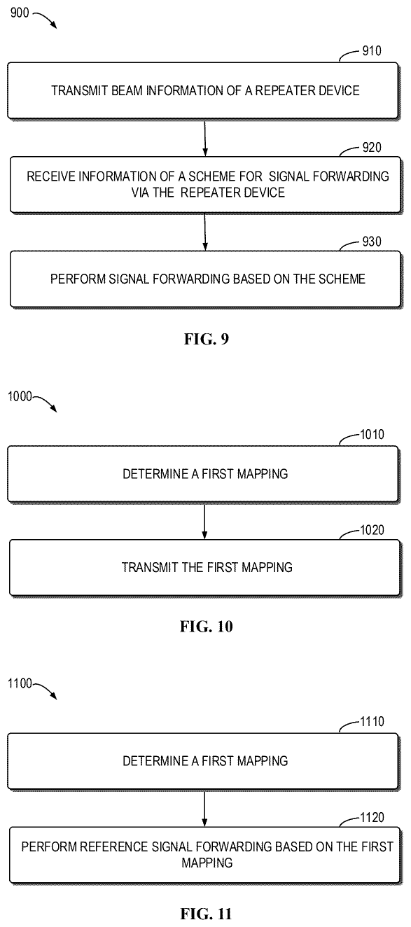

FIG. 10 illustrates another example method 1000 of communication implemented at a network device in accordance with some embodiments of the present disclosure. For example, the method 1000 may be performed at the network device 110 as shown in FIG. 1A. For the purpose of discussion, in the following, the method 1000 will be described with reference to FIG. 1A. It is to be understood that the method 1000 may include additional blocks not shown and/or may omit some blocks as shown, and the scope of the present disclosure is not limited in this regard.

At block 1010, the network device 110 determines a first mapping between a set of first beams of the network device 110 for reference signal transmission and a set of second beams of the repeater device 120 for reference signal forwarding.

In some embodiments, the network device 110 may receive first information of the set of second beams, and determine the first mapping based on the first information of the set of second beams.

In some embodiments, the first information may comprise at least one of the following: information of a beam direction of a second beam in the set of second beams; information of beam coverage of a second beam in the set of second beams; information of interference between a second beam in the set of second beams and a third beam in a set of third beams of the repeater device 120 for reference signal reception; or information of correspondence between a second beam in the set of second beams and a third beam in a set of third beams of the repeater device 120 for reference signal reception.

In some embodiments, the network device 110 may associate a first beam in the set of first beams with a second beam in the set of second beams. In some embodiments, the network device 110 may associate a second beam in the set of second beams with a subset of first beams in the set of first beams.

At block 1020, the network device 110 transmits the first mapping to the repeater device 120.

In some embodiments, the network device 110 may receive, from the repeater device 120, channel measurements for a set of beam pairs formed by the set of first beams and a set of third beams of the repeater device 120 for reference signal reception. The network device 110 may determine a second mapping between a first beam in the set of first beams and a third beam in the set of third beams, and transmit the second mapping to the repeater device 120.

In some embodiments, the network device 110 may receive a measured value associated with a beam pair in the set of beam pairs, the measured value being above a first threshold value. In some embodiments, the network device 110 may receive information of a third beam in the set of third beams, the third beam being associated with a first beam in the set of first beams. In some embodiments, the network device 110 may receive an indication of absence of the third beam associated with the first beam. It is to be understood that the network device 110 may receive any combination of the above information.

In some embodiments, the network device 110 may further determine transmission power associated with a beam pair in the set of beam pairs, and transmit the transmission power to the repeater device 120. In some embodiments, the network device 110 may determine a reference measured value from a set of measured values associated with the set of beam pairs, the reference measured value being above a second threshold value. The network device 110 may determine reference transmission power for a second beam associated with a first beam in a further beam pair, the further beam pair being associated with the reference measured value. Then the network device 110 may determine the transmission power associated with the beam pair at least based on the reference transmission power, the reference measured value, and a measured value associated with the beam pair.

In some embodiments, the network device 110 may further receive a PRACH signal in a time-frequency location configured for the repeater device 120.

In some embodiments, the network device 110 may further determine a third mapping between a set of first beams of the network device for further reference signal transmission and a set of second beams of the repeater device for further reference signal forwarding, and transmit the third mapping to the repeater device 120.

With the method 1000, a signal forwarding scheme without extending a reference signal index may be facilitated.

FIG. 11 illustrates an example method 1100 of communication implemented at a repeater device in accordance with some embodiments of the present disclosure. For example, the method 1100 may be performed at the repeater device 120 as shown in FIG. 1A. For the purpose of discussion, in the following, the method 1100 will be described with reference to FIG. 1A. It is to be understood that the method 1100 may include additional blocks not shown and/or may omit some blocks as shown, and the scope of the present disclosure is not limited in this regard.

At block 1110, the repeater device 120 determines a first mapping between a set of first beams of the network device 110 for reference signal transmission and a set of second beams of the repeater device 120 for reference signal forwarding.

In some embodiments, the repeater device 120 may transmit, to the network device 110, first information of the set of second beams, and receive the first mapping from the network device 110.

In some embodiments, the first information may comprise at least one of the following: information of a beam direction of a second beam in the set of second beams; information of beam coverage of a second beam in the set of second beams; information of interference between a second beam in the set of second beams and a third beam in a set of third beams of the repeater device 120 for reference signal reception; or information of correspondence between a second beam in the set of second beams and a third beam in a set of third beams of the repeater device 120 for reference signal reception.

In some embodiments, the repeater device 120 may determine information of correspondence between a second beam in the set of second beams and a third beam in a set of third beams of the repeater device 120 for reference signal reception. In these embodiments, the repeater device 120 may determine the first mapping based on the information of the correspondence by associating a first beam in the set of first beams with a second beam in the set of second beams or associating a second beam in the set of second beams with a subset of first beams in the set of first beams.

At block 1120, the repeater device 120 performs the reference signal forwarding based on the first mapping.

In some embodiments, the repeater device 120 may transmit, to the network device 110, channel measurements for a set of beam pairs formed by the set of first beams and a set of third beams of the repeater device 120 for reference signal reception. In these embodiments, the repeater device 120 may receive, from the network device 110, a second mapping between a first beam in the set of first beams and a third beam in the set of third beams.

In some embodiments, the repeater device 120 may transmit at least one of the following: a measured value associated with a beam pair in the set of beam pairs, the measured value being above a first threshold value; information of a third beam in the set of third beams, the third beam being associated with a first beam in the set of first beams; or an indication of absence of the third beam associated with the first beam.

In some embodiments, the repeater device 120 may further receive, from the network device 110, transmission power associated with a beam pair in the set of beam pairs.

In some embodiments, the repeater device 120 may receive a PRACH signal from the terminal device 130 in a first time-frequency location, and transmit the PRACH signal to the network device 110 in a second time-frequency location configured for the repeater device 120.

In some embodiments, the second time-frequency location may have a first predetermined offset with respect to the first time-frequency location in frequency domain.

In some embodiments, the second time-frequency location may have a second predetermined offset with respect to the first time-frequency location in time domain.

With the method 1100, a signal forwarding scheme without extending a reference signal index may be achieved.

FIG. 12 illustrates another example method 1200 of communication implemented at a repeater device in accordance with some embodiments of the present disclosure. For example, the method 1200 may be performed at the repeater device 120 as shown in FIG. 1A. For the purpose of discussion, in the following, the method 1200 will be described with reference to FIG. 1A. It is to be understood that the method 1200 may include additional blocks not shown and/or may omit some blocks as shown, and the scope of the present disclosure is not limited in this regard.

At block 1210, the repeater device 120 receives, from the network device 110, a mapping between a set of first beams of the network device 110 for reference signal transmission and a set of second beams of the repeater device 120 for reference signal forwarding.

At block 1220, the repeater device 120 determines an application time of the mapping.

In some embodiments, the repeater device 120 may determine a reference time based on a time of the receiving of the mapping and a signaling processing time of the repeater device 120, and determine a time offset based on the reference time and an occasion of reference signal transmission. Then the repeater device 120 may determine the application time based on the time of the receiving of the mapping and the time offset.

In some embodiments, if the occasion starts before the reference time and ends after the reference time, the repeater device 120 may determine, as the time offset, a time gap between the time of the receiving of the mapping and an ending edge of the occasion. In some embodiments, if the occasion starts before the reference time and ends after the reference time, the repeater device 120 may determine, as the time offset, a time gap between the time of the receiving of the mapping and a starting edge of a further occasion of reference signal transmission, the further occasion being later than the occasion. In some embodiments, if the occasion starts before the reference time and ends after the reference time, the repeater device 120 may determine, as the time offset, a time gap between the time of the receiving of the mapping and a time of receiving a feedback from a terminal device for a predetermined reference signal transmission related to the occasion.

In some embodiments, if the occasion ends before the reference time and a further occasion of reference signal transmission starts after the reference time, the repeater device 120 may determine, as the time offset, the signaling processing time of the repeater device 120. In some embodiments, if the occasion ends before the reference time and a further occasion of reference signal transmission starts after the reference time, the repeater device 120 may determine, as the time offset, a time gap between the time of the receiving of the mapping and a starting edge of the further occasion. In some embodiments, if the occasion ends before the reference time and a further occasion of reference signal transmission starts after the reference time, the repeater device 120 may determine, as the time offset, a time gap between the time of the receiving of the mapping and a time of receiving a feedback from the terminal device 130 for a predetermined reference signal transmission related to the occasion.

In some embodiments, the repeater device 120 may determine the time offset as zero. In these embodiments, if the occasion starts before the reference time and ends after the reference time, the repeater device 120 may transmit information of the reference time to the network device 110.

At block 1230, the repeater device 120 applies, based on the application time, the mapping for the reference signal forwarding.

With the method 1200, a NCR may determine an application time of a mapping between Tx beams of a network device and a NCR.

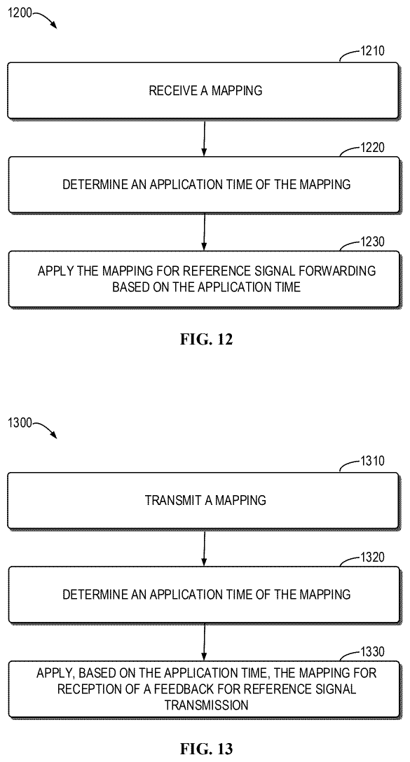

FIG. 13 illustrates another example method 1300 of communication implemented at a network device in accordance with some embodiments of the present disclosure. For example, the method 1300 may be performed at the network device 110 as shown in FIG. 1A. For the purpose of discussion, in the following, the method 1300 will be described with reference to FIG. 1A. It is to be understood that the method 1300 may include additional blocks not shown and/or may omit some blocks as shown, and the scope of the present disclosure is not limited in this regard.

At block 1310, the network device 110 transmits, to the repeater device 120, a mapping between a set of first beams of the network device 110 for reference signal transmission and a set of second beams of the repeater device 120 for reference signal forwarding.

At block 1320, the network device 110 determines an application time of the mapping.

In some embodiments, the network device 110 may determine a reference time based on a time of the transmitting of the mapping and a signaling processing time of the repeater device 120, and determine a time offset based on the reference time and an occasion of reference signal transmission. Then the network device 110 may determine the application time based on the time of the transmitting of the mapping and the time offset.

In some embodiments, if the occasion starts before the reference time and ends after the reference time, the network device 110 may determine, as the time offset, a time gap between the time of the transmitting of the mapping and an ending edge of the occasion. In some embodiments, if the occasion starts before the reference time and ends after the reference time, the network device 110 may determine, as the time offset, a time gap between the time of the transmitting of the mapping and a starting edge of a further occasion of reference signal transmission, the further occasion being later than the occasion. In some embodiments, if the occasion starts before the reference time and ends after the reference time, the network device 110 may determine, as the time offset, a time gap between the time of the transmitting of the mapping and a time of receiving a feedback from the terminal device 130 for a predetermined reference signal transmission related to the occasion.

In some embodiments, if the occasion ends before the reference time and a further occasion of reference signal transmission starts after the reference time, the network device 110 may determine, as the time offset, the signaling processing time of the repeater device 120. In some embodiments, if the occasion ends before the reference time and a further occasion of reference signal transmission starts after the reference time, the network device 110 may determine, as the time offset, a time gap between the time of the transmitting of the mapping and a starting edge of the further occasion. In some embodiments, if the occasion ends before the reference time and a further occasion of reference signal transmission starts after the reference time, the network device 110 may determine, as the time offset, a time gap between the time of the transmitting of the mapping and a time of receiving a feedback from the terminal device 130 for a predetermined reference signal transmission related to the occasion.

In some embodiments, the network device 110 may determine the time offset as zero, and the occasion may start before the reference time and end after the reference time. In these embodiments, the network device 110 may receive information of the reference time from the repeater device 120, and discard at least a part of measurements associated with the occasion for the terminal device 130 associated with the repeater device 120.

In some embodiments, the network device 110 may discard a first part of the measurements associated with a first portion of the occasion between the reference time and an ending edge of the occasion. In some embodiments, the network device 110 may discard a second part of the measurements associated with a second portion of the occasion between a starting edge of the occasion and the reference time. In some embodiments, the network device 110 may discard a smaller one of the first part and the second part.

At block 1330, the network device 110 applies, based on the application time, the mapping for reception of a feedback for the reference signal transmission.

With the method 1300, a network device may determine an application time of a mapping between Tx beams of a network device and a NCR.

It is to be understood that operations of methods 800 to 1300 are similar to that described in connection with FIGS. 2 to 4, and thus other details are omitted here for concise.

### Example Implementation of Device and Apparatus

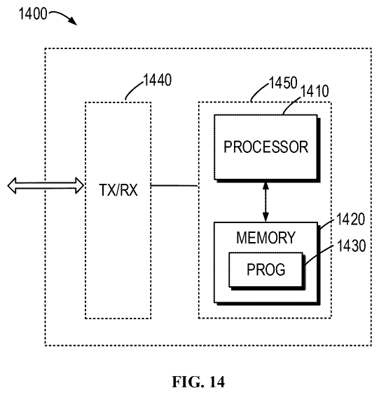

FIG. 14 is a simplified block diagram of a device 1400 that is suitable for implementing embodiments of the present disclosure. The device 1400 can be considered as a further example implementation of the network device 110 or the repeater device 120 or the terminal device 130 as shown in FIG. 1. Accordingly, the device 1400 can be implemented at or as at least a part of the network device 110 or the repeater device 120 or the terminal device 130.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1A to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a network device comprises a circuitry configured to: receive, from at least one repeater device in a set of repeater devices, beam information of the at least one repeater device; determine, based on the beam information, information of a scheme for signal forward via the at least one repeater device; and transmitting the information of the scheme to the at least one repeater device.

In some embodiments, a repeater device comprises a circuitry configured to: transmit, to a network device, beam information of the repeater device; receive, from the network device, information of a scheme for signal forwarding via the repeater device; and perform signal forwarding based on the scheme.

In some embodiments, a network device comprises a circuitry configured to: determine a first mapping between a set of first beams of the network device for reference signal transmission and a set of second beams of a repeater device for reference signal forwarding; and transmit the first mapping to the repeater device.

In some embodiments, a repeater device comprises a circuitry configured to: determine a first mapping between a set of first beams of a network device for reference signal transmission and a set of second beams of the repeater device for reference signal forwarding; and perform the reference signal forwarding based on the first mapping.

In some embodiments, a repeater device comprises a circuitry configured to: receive, from a network device, a mapping between a set of first beams of the network device for reference signal transmission and a set of second beams of the repeater device for reference signal forwarding; determine an application time of the mapping; and apply, based on the application time, the mapping for the reference signal forwarding.

In some embodiments, a repeater device comprises a circuitry configured to: transmit, to a repeater device, a mapping between a set of first beams of the network device for reference signal transmission and a set of second beams of the repeater device for reference signal forwarding; determine an application time of the mapping; and apply, based on the application time, the mapping for reception of a feedback for the reference signal transmission.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: receiving, at a network device and from at least one repeater device in a set of repeater devices, beam information of the at least one repeater device; determining, based on the beam information, information of a scheme for signal forwarding via the at least one repeater device; and transmitting the information of the scheme to the at least one repeater device.

In some embodiments, determining the information of the scheme comprises: determining, from the beam information, a first number of beams associated with the set of repeater devices; in accordance with a determination that the first number of beams is above a first threshold number, determining, as the scheme for signal forwarding via the set of repeater devices, a first scheme without extending a reference signal index; and in accordance with a determination that the first number of beams is below a second threshold number, determining, as the scheme for signal forwarding via the set of repeater devices, a second scheme with extending the reference signal index.

In some embodiments, the first threshold number is equal to or greater than the second threshold number.

In some embodiments, the first threshold number is greater than the second threshold number, and determining the information of the scheme further comprises: in accordance with a determination that the first number of beams is below the first threshold number and is above the second threshold number, determining, based on a traffic load associated with the network device or the at least one repeater device, the scheme for signal forwarding via the at least one repeater device.

In some embodiments, the at least one repeater device comprises a repeater device, and determining the information of the scheme comprises: determining, from the beam information, a second number of beams associated with the repeater device; in accordance with a determination that the second number of beams is above a third threshold number, determining, as the scheme for signal forwarding via the repeater device, a first scheme without extending a reference signal index; and in accordance with a determination that the second number of beams is below the third threshold number, determining, as the scheme for signal forwarding via the repeater device, a second scheme with extending a reference signal index.

In some embodiments, a scheme for signal forwarding via a first repeater device is the first scheme and a scheme for signal forwarding via a second repeater device is the second scheme, and wherein the method further comprises: in accordance with a determination that a reference signal transmission via the second repeater device is performed, transmitting, to the first repeater device, an indication indicating turn-off of the first repeater device.

In some embodiments, determining the information of the scheme comprises: determining, from the beam information, a fourth threshold number for determination of the scheme by the at least one repeater device.

In another solution, a method of communication comprises: transmitting, at a repeater device and to a network device, beam information of the repeater device; receiving, from the network device, information of a scheme for signal forwarding via the repeater device; and performing signal forwarding based on the scheme.

In some embodiments, receiving the information of the scheme comprises: receiving an indication of a first scheme without extending a reference signal index; or receiving an indication of a second scheme with extending a reference signal index.

In some embodiments, receiving the information of the scheme comprises: receiving, from the network device, a fourth threshold number for determination of the scheme by the repeater device.

In some embodiments, the method above further comprises: in accordance with a determination that a number of beams of the repeater device is above the fourth threshold number, determining, as the scheme for signal forwarding via the repeater device, a first scheme without extending a reference signal index; and in accordance with a determination that the number of beams of the repeater device is below the fourth threshold number, determining, as the scheme for signal forwarding via the repeater device, a second scheme with extending a reference signal index.

In another solution, a method of communication comprises: determining, at a network device, a first mapping between a set of first beams of the network device for reference signal transmission and a set of second beams of a repeater device for reference signal forwarding; and transmit the first mapping to the repeater device.

In some embodiments, determining the first mapping comprises: receiving first information of the set of second beams; and determining the first mapping based on the first information of the set of second beams.

In some embodiments, the first information comprises at least one of the following: information of a beam direction of a second beam in the set of second beams; information of beam coverage of a second beam in the set of second beams; information of interference between a second beam in the set of second beams and a third beam in a set of third beams of the repeater device for reference signal reception; or information of correspondence between a second beam in the set of second beams and a third beam in a set of third beams of the repeater device for reference signal reception.

In some embodiments, determining the first mapping comprises: associating a first beam in the set of first beams with a second beam in the set of second beams; or associating a second beam in the set of second beams with a subset of first beams in the set of first beams.

In some embodiments, the method further comprises: receiving, from the repeater device, channel measurements for a set of beam pairs formed by the set of first beams and a set of third beams of the repeater device for reference signal reception; determining a second mapping between a first beam in the set of first beams and a third beam in the set of third beams; and transmitting the second mapping to the repeater device.

In some embodiments, receiving the channel measurements comprises at least one of the following: receiving a measured value associated with a beam pair in the set of beam pairs, the measured value being above a first threshold value; receiving information of a third beam in the set of third beams, the third beam being associated with a first beam in the set of first beams; or receiving an indication of absence of the third beam associated with the first beam.

In some embodiments, the method further comprises: determining transmission power associated with a beam pair in the set of beam pairs; and transmitting the transmission power to the repeater device.

In some embodiments, determining the transmission power comprises: determining a reference measured value from a set of measured values associated with the set of beam pairs, the reference measured value being above a second threshold value; determining reference transmission power for a second beam associated with a first beam in a further beam pair, the further beam pair being associated with the reference measured value; and determining the transmission power associated with the beam pair at least based on the reference transmission power, the reference measured value, and a measured value associated with the beam pair.

In some embodiments, the method further comprises: receiving a physical random access channel signal in a time-frequency location configured for the repeater device.

In some embodiments, the method further comprises: determining a third mapping between a set of first beams of the network device for further reference signal transmission and a set of second beams of the repeater device for further reference signal forwarding; and transmitting the third mapping to the repeater device.

In another solution, a method of communication comprises: determining, at a repeater device, a first mapping between a set of first beams of a network device for reference signal transmission and a set of second beams of the repeater device for reference signal forwarding; and performing the reference signal forwarding based on the first mapping.

In some embodiments, determining the first mapping comprises: transmitting, to a network device, first information of the set of second beams; and receiving the first mapping from the network device.

In some embodiments, the first information comprises at least one of the following: information of a beam direction of a second beam in the set of second beams; information of beam coverage of a second beam in the set of second beams; information of interference between a second beam in the set of second beams and a third beam in a set of third beams of the repeater device for reference signal reception; or information of correspondence between a second beam in the set of second beams and a third beam in a set of third beams of the repeater device for reference signal reception.

In some embodiments, determining the first mapping comprises: determining information of correspondence between a second beam in the set of second beams and a third beam in a set of third beams of the repeater device for reference signal reception; and determining the first mapping based on the information of the correspondence by associating a first beam in the set of first beams with a second beam in the set of second beams or associating a second beam in the set of second beams with a subset of first beams in the set of first beams.

In some embodiments, performing the reference signal forwarding comprises: transmitting, to the network device, channel measurements for a set of beam pairs formed by the set of first beams and a set of third beams of the repeater device for reference signal reception; and receiving, from the network device, a second mapping between a first beam in the set of first beams and a third beam in the set of third beams.

In some embodiments, transmitting the channel measurements comprises at least one of the following: transmitting a measured value associated with a beam pair in the set of beam pairs, the measured value being above a first threshold value; transmitting information of a third beam in the set of third beams, the third beam being associated with a first beam in the set of first beams; or transmitting an indication of absence of the third beam associated with the first beam.

In some embodiments, the method further comprises: receiving, from the network device, transmission power associated with a beam pair in the set of beam pairs.

In some embodiments, performing the reference signal forwarding comprises: receiving a physical random access channel signal from a terminal device in a first time-frequency location; and transmitting the physical random access channel signal to a network device in a second time-frequency location configured for the repeater device.

In some embodiments, the second time-frequency location has a first predetermined offset with respect to the first time-frequency location in frequency domain; or the second time-frequency location has a second predetermined offset with respect to the first time-frequency location in time domain.

In another solution, a method of communication comprises: receiving, at a repeater device and from a network device, a mapping between a set of first beams of the network device for reference signal transmission and a set of second beams of the repeater device for reference signal forwarding; determining an application time of the mapping; and applying, based on the application time, the mapping for the reference signal forwarding.

In some embodiments, determining the application time comprises: determining a reference time based on a time of the receiving of the mapping and a signaling processing time of the repeater device; determining a time offset based on the reference time and an occasion of reference signal transmission; and determining the application time based on the time of the receiving of the mapping and the time offset.

In some embodiments, determining the time offset comprises: in accordance with a determination that the occasion starts before the reference time and ends after the reference time, determining, as the time offset, a time gap between the time of the receiving of the mapping and an ending edge of the occasion; determining, as the time offset, a time gap between the time of the receiving of the mapping and a starting edge of a further occasion of reference signal transmission, the further occasion being later than the occasion; or determining, as the time offset, a time gap between the time of the receiving of the mapping and a time of receiving a feedback from a terminal device for a predetermined reference signal transmission related to the occasion.

In some embodiments, determining the time offset comprises: in accordance with a determination that the occasion ends before the reference time and a further occasion of reference signal transmission starts after the reference time, determining, as the time offset, the signaling processing time of the repeater device; determining, as the time offset, a time gap between the time of the receiving of the mapping and a starting edge of the further occasion; or determining, as the time offset, a time gap between the time of the receiving of the mapping and a time of receiving a feedback from a terminal device for a predetermined reference signal transmission related to the occasion.

In some embodiments, determining the time offset comprises determining the time offset as zero, and the method above further comprises: in accordance with a determination that the occasion starts before the reference time and ends after the reference time, transmitting information of the reference time to the network device.

In another solution, a method of communication comprises: transmitting, at a network device and to a repeater device, a mapping between a set of first beams of the network device for reference signal transmission and a set of second beams of the repeater device for reference signal forwarding; determining an application time of the mapping; and applying, based on the application time, the mapping for reception of a feedback for the reference signal transmission.

In some embodiments, determining the application time comprises: determining a reference time based on a time of the transmitting of the mapping and a signaling processing time of the repeater device; determining a time offset based on the reference time and an occasion of reference signal transmission; and determining the application time based on the time of the transmitting of the mapping and the time offset.

In some embodiments, determining the time offset comprises: in accordance with a determination that the occasion starts before the reference time and ends after the reference time, determining, as the time offset, a time gap between the time of the transmitting of the mapping and an ending edge of the occasion; determining, as the time offset, a time gap between the time of the transmitting of the mapping and a starting edge of a further occasion of reference signal transmission, the further occasion being later than the occasion; or determining, as the time offset, a time gap between the time of the transmitting of the mapping and a time of receiving a feedback from a terminal device for a predetermined reference signal transmission related to the occasion.

In some embodiments, determining the time offset comprises: in accordance with a determination that the occasion ends before the reference time and a further occasion of reference signal transmission starts after the reference time, determining, as the time offset, the signaling processing time of the repeater device; determining, as the time offset, a time gap between the time of the transmitting of the mapping and a starting edge of the further occasion; or determining, as the time offset, a time gap between the time of the transmitting of the mapping and a time of receiving a feedback from a terminal device for a predetermined reference signal transmission related to the occasion.

In some embodiments, determining the time offset comprises determining the time offset as zero, and the occasion starts before the reference time and ends after the reference time, and the method above further comprises: receiving information of the reference time from the repeater device; and discarding at least a part of measurements associated with the occasion for a terminal device associated with the repeater device.

In some embodiments, discarding at least the part of measurements comprises: discarding a first part of the measurements associated with a first portion of the occasion between the reference time and an ending edge of the occasion; discarding a second part of the measurements associated with a second portion of the occasion between a starting edge of the occasion and the reference time; or discarding a smaller one of the first part and the second part.

In another solution, a device of communication comprises: a processor configured to cause the device to perform the method according to any of the methods described above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a network device and from at least one repeater device in a set of repeater devices, beam information of the at least one repeater device;
determining, based on the beam information, information of a scheme for signal forwarding via the at least one repeater device; and
transmitting the information of the scheme to the at least one repeater device.

2. The method of claim 1, wherein determining the information of the scheme comprises:
determining, from the beam information, a first number of beams associated with the set of repeater devices;
in accordance with a determination that the first number of beams is above a first threshold number, determining, as the scheme for signal forwarding via the set of repeater devices, a first scheme without extending a reference signal index; and
in accordance with a determination that the first number of beams is below a second threshold number, determining, as the scheme for signal forwarding via the set of repeater devices, a second scheme with extending the reference signal index.

3. The method of claim 2, wherein the first threshold number is equal to or greater than the second threshold number.

4. The method of claim 3, wherein the first threshold number is greater than the second threshold number, and wherein determining the information of the scheme further comprises:
in accordance with a determination that the first number of beams is below the first threshold number and is above the second threshold number, determining, based on a traffic load associated with the at least one repeater device, the scheme for signal forwarding via the at least one repeater device.

5. The method of claim 1, wherein the at least one repeater device comprises a repeater device, and wherein determining the information of the scheme comprises:
determining, from the beam information, a second number of beams associated with the repeater device;
in accordance with a determination that the second number of beams is above a third threshold number, determining, as the scheme for signal forwarding via the repeater device, a first scheme without extending a reference signal index; and
in accordance with a determination that the second number of beams is below the third threshold number, determining, as the scheme for signal forwarding via the repeater device, a second scheme with extending a reference signal index.

6. The method of claim 5, wherein a scheme for signal forwarding via a first repeater device is the first scheme and a scheme for signal forwarding via a second repeater device is the second scheme, and wherein the method further comprises:
in accordance with a determination that a reference signal transmission via the second repeater device is performed, transmitting, to the first repeater device, an indication indicating turn-off of the first repeater device.

7. The method of claim 1, wherein determining the information of the scheme comprises:
determining, from the beam information, a fourth threshold number for determination of the scheme by the at least one repeater device.

8. A method of communication, comprising:
determining, at a network device, a first mapping between a set of first beams of the network device for reference signal transmission and a set of second beams of a repeater device for reference signal forwarding; and
transmitting the first mapping to the repeater device.

9. The method of claim 8, wherein determining the first mapping comprises:
receiving first information of the set of second beams; and
determining the first mapping based on the first information of the set of second beams.

10. The method of claim 9, wherein the first information comprises at least one of the following:
information of a beam direction of a second beam in the set of second beams;
information of beam coverage of a second beam in the set of second beams;
information of interference between a second beam in the set of second beams and a third beam in a set of third beams of the repeater device for reference signal reception; or
information of correspondence between a second beam in the set of second beams and a third beam in a set of third beams of the repeater device for reference signal reception.

11. The method of claim 9, wherein determining the first mapping comprises:
associating a first beam in the set of first beams with a second beam in the set of second beams; or
associating a second beam in the set of second beams with a subset of first beams in the set of first beams.

12. The method of claim 8, further comprising:
receiving, from the repeater device, channel measurements for a set of beam pairs formed by the set of first beams and a set of third beams of the repeater device for reference signal reception;
determining a second mapping between a first beam in the set of first beams and a third beam in the set of third beams; and
transmitting the second mapping to the repeater device.

13. The method of claim 12, further comprising:
determining transmission power associated with a beam pair in the set of beam pairs; and
transmitting the transmission power to the repeater device.

14. The method of claim 13, wherein determining the transmission power comprises:
determining a reference measured value from a set of measured values associated with the set of beam pairs, the reference measured value being above a second threshold value;
determining reference transmission power for a second beam associated with a first beam in a further beam pair, the further beam pair being associated with the reference measured value; and
determining the transmission power associated with the beam pair at least based on the reference transmission power, the reference measured value, and a measured value associated with the beam pair.

15. A method of communication, comprising:
determining, at a repeater device, a first mapping between a set of first beams of a network device for reference signal transmission and a set of second beams of the repeater device for reference signal forwarding; and
performing the reference signal forwarding based on the first mapping.

16. The method of claim 15, wherein determining the first mapping comprises:
transmitting, to a network device, first information of the set of second beams; and
receiving the first mapping from the network device.

17. The method of claim 16, wherein the first information comprises at least one of the following:
information of a beam direction of a second beam in the set of second beams;
information of beam coverage of a second beam in the set of second beams;
information of interference between a second beam in the set of second beams and a third beam in a set of third beams of the repeater device for reference signal reception; or
information of correspondence between a second beam in the set of second beams and a third beam in a set of third beams of the repeater device for reference signal reception.

18. The method of claim 15, wherein performing the reference signal forwarding comprises:
transmitting, to the network device, channel measurements for a set of beam pairs formed by the set of first beams and a set of third beams of the repeater device for reference signal reception; and
receiving, from the network device, a second mapping between a first beam in the set of first beams and a third beam in the set of third beams.

19. The method of claim 18, further comprising:
receiving, from the network device, transmission power associated with a beam pair in the set of beam pairs.

20. The method of claim 15, wherein performing the reference signal forwarding comprises:
receiving a physical random access channel signal from a terminal device in a first time-frequency location; and
transmitting the physical random access channel signal to a network device in a second time-frequency location configured for the repeater device.
